(19) United States
(12) Patent Application Publication
(10) Pub. No.: US 2007/0026267 A1
(43) Pub. Date: Feb. 1, 2007

(54) Fuel cell system provided with a cooling circuit

(76) Inventors: Uli Paulus, Deckenpfronn (DE); Dirk Schroeter, Winnenden (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/529,837

(22) PCT Filed: Sep. 12, 2003
(86) PCT No.: PCT/EP03/10148

§ 371 Date: Sep. 27, 2006

(30) Foreign Application Priority Data
Oct. 1, 2002 (DE) 10245794.8

(51) Int. Cl. H01M 8/04

(52) U.S. Cl. 429/13; 429/26; 429/34

(57) ABSTRACT

A method and apparatus for cooling a fuel cell system. The system includes a fuel cell (1) having a cooling device (15) which forms part of a cooling circuit including a liquid coolant. The cooling circuit, outside the fuel cell (1), contains a device by which any gases which may penetrate into the liquid coolant from the fuel cell (1) are separated out and fed to the mass flow of the oxygen-containing gas which is fed into the fuel cell.

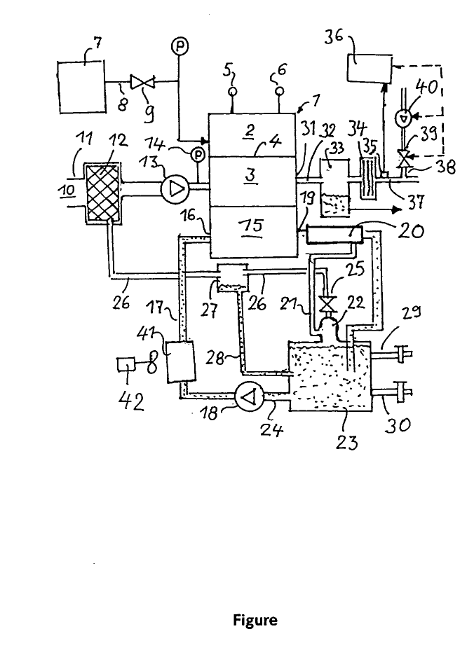

This application claims priority to International Patent Application No. PCT/EP03/10148, filed Sep. 12, 2003, designating the United States of America, and German Application DE 102 45 794.8 filed on Oct. 1, 2002, the entire disclosure of which is incorporated herein by reference.

### BACKGROUND AND SUMMARY OF THE INVENTION

The invention relates to a method and an apparatus for cooling a fuel cell system having a fuel cell, which includes an anode space, to which a hydrogen-containing gas is fed, and a cathode space, to which an oxygen-containing gas is fed via an air intake system, a cooling device, which forms part of a cooling circuit through which a liquid coolant is passed, being arranged at least in the fuel cell. In this context, the term fuel cell is to be understood as meaning both a single fuel cell and also a stack made up of a plurality of fuel cells which form a stack.

An energy generation system having a fuel cell system which comprises an electrochemical fuel cell including an anode space and a cathode space, which are separated by a proton-conducting membrane, is known. Oxygen containing gas, in particular air, is fed to the cathode space, and a hydrogen-containing gas is fed to the anode space. The fuel cell is designed as a fuel cell stack and includes a cooling device or a heat exchanger, which is part of a closed cooling circuit in which a pump circulates the coolant water. The cooling circuit includes a reservoir, an inlet of which is connected to an exit of the cooling device of the fuel cell, and an outlet of which is connected to the pump which feeds the water into the entry to the cooling device of the fuel cell as disclosed in European Patent No. EP 0 800 708 B1.

While the fuel cell with a cooling device arranged in its interior is operating, under certain circumstances hydrogen-containing fuel gas and/or air may penetrate into the coolant. This penetration of these gases into the coolant may be caused by leaks or diffusion. This is the starting point for the present invention, which is based on the problem of providing a method and an apparatus for cooling a fuel cell system having at least one heat exchanger which is arranged in a fuel cell, which has a cycle of a liquid coolant flowing through it and in which danger caused by the formation of an ignitable mixture of gases is avoided despite the penetration of gases from the anode space and/or cathode space of the fuel cell.

The problem discussed above is solved, according to the invention, by the fact that gaseous constituents contained in the liquid coolant are separated off in the cooling circuit outside the fuel cell and fed to the air intake system via a discharge passage which does not include any ignition sources for an ignitable mixture. The invention is based on the principle of feeding any gas contained in the coolant to the air intake system, in which it is mixed with a very considerable air stream. This mixing reduces the level of a gas which may originate from the fuel cell and forms an ignitable mixture at a defined ratio with oxygen in the mass flow of air to such an extent that it is no longer possible for an ignitable mixture to form. It is impossible for an ignitable mixture to form in the liquid coolant on account of the gases being. dissolved and/or the formation of extremely small gas bubbles which float in the liquid coolant.

In one expedient embodiment, coolant which emerges from the exit of the cooling device of the fuel cell is fed to a calming vessel from which gas is discharged at a preset excess-pressure level. The gas is fed via the discharge passage to the mass flow of oxygen-containing gas of the air intake system, which is closed when the pressure drops below the excess pressure level, in order to prevent gas from escaping to the discharge passage.

In the event of gases from the fuel cell penetrating into the coolant, the dissolving properties of the latter are changed as a result of being heated in such a way that dissolved gases are converted into extremely small bubbles which float up. This mixture passes into the calming vessel, in which the gas bubbles are separated out. In the calming vessel the gas passes upward into a gas collection region, building up a gas pressure. When a predetermined preset pressure level is reached the discharge passage for discharging the gas is opened, and after the pressure in the calming vessel has dropped below a predeterminable value this passage is blocked again, so that it is impossible for any cooling liquid to enter the discharge passage.

In one expedient embodiment, any gas which is present in the liquid coolant is separated out of the coolant by means of a vent line upstream of the calming vessel and fed to the calming vessel. In this way, very good degassing of the coolant is achieved by two methods.

It is preferably for gases from the discharge passage to be fed to the mass flow of air in the region of an air filter of the air intake system. This results in good and uniform mixing.

In a further expedient embodiment, the hydrogen content of the exhaust gases from the fuel cell is monitored using a hydrogen sensor, with the concentration of hydrogen in the exhaust gas being reduced to below a preset limit value for the gas content when this limit value is reached by admixing hydrogen-free gas. This measure allows the hydrogen gas content to be lowered to a very low level.

In another expedient embodiment, the exhaust gases from the fuel cell are. passed over a catalyst, by means of which the hydrogen concentration in the exhaust gases is reduced.

It is expedient for a compressor in the air intake system for feeding air into the fuel cell to be set to continue to run for a predeterminable period of time after the fuel cell has been switched off and the circulation of coolant shut down. In this way, any fuel gas and/or hydrogen which may still be present in the air intake system is removed from it by purging.

In an apparatus of the type described in the introduction, the problem is solved, according to the invention, by the fact that a. calming vessel for the liquid coolant with a gas collection region is downstream of the outlet or exit of the connected the fuel cell. A gas outlet valve cooling device of is arranged at the gas collection region, which valve can be actuated at a predeterminable gas volume or gas pressure in the calming vessel and on the exit side is connected, via a discharge passage which does not include any ignition sources for an ignitable gas mixture, to the intake system for the oxygen-containing gas. The oxygen-containing gas is generally air. The cooling device according to the invention prevents gases which penetrate into the coolant from the fuel cell, for example, through diffusion or leaks, from reaching ignition sourcese where explosive combustion could take place at a critical concentration. The cooling device of the type described above allows the fuel cell and cooling circuit to operate safely despite gases from the fuel cell penetrating into the coolant.

It is preferable for a vent line to be arranged between the exit or outlet of the cooling device of the fuel cell and the gas collection region of the calming vessel. The term vent line is also to be understood as meaning a line by means of which gases, i.e. not just air, are separated out of a liquid. This further embodiment and the calming vessel effect very successful degassing of the coolant in two different ways.

It is particularly expedient if the discharge passage whichleads from the calming vessel opens out in the gas intake system for the, oxygen-containing gas in the region of a gas filter, since this leads to uniform mixing of the gases with the oxygen-containing gas, preferably air. The mixing significantly reduces the concentration of any gas which has been entrained from the fuel cell via the cooling circuit in the gas stream fed to the fuel cell. Any fuel gas which may he present in the oxygen-containing gas stream passes into the fuel cell, i.e. into the cathode space, and leaves the latter together with the exhaust gases formed therein via the exhaust-gas exit.

In another preferred embodiment, a sensor for measuring the fuel gas content in the exhaust-gas stream is provided in the exhaust pipe for the reaction products of the fuel cell and is connected to a control unit, in which a limit value for the fuel gas content in the exhaust-gas stream is set and by which it is possible to control a valve in an entry to the exhaust pipe. The valve opens up an opening in the exhaust pipe for admixing air when the set limit value is reached.

In one expedient embodiment, a catalyst for reducing the fuel gas in the exhaust-gas stream is present within the exhaust pipe. This therefore provides a redundant reduction in the fuel gas content, in particular the hydrogen content, in the exhaust-gas stream, thereby ensuring that the fuel gas is reliably reduced.

According to the embodiment the. calming vessel, the gas outlet valve and the discharge passage consist of antistatic materials, thereby avoiding static charging and the formation of electrical discharges.

The invention is described in more detail below on the basis of an exemplary embodiment illustrated in a drawing, which will reveal further details, features and advantages.

### BRIEF DESCRIPTION OF THE DRAWINGS

The sole drawing diagrammatically depicts a fuel cell system having a fuel cell which, in its interior, has a cooling device or a heat exchanger, the cooling device being arranged in a cooling circuit through which a liquid coolant is passed.

### DETAILED DESCRIPTION OF THE DRAWINGS

The fuel cell system for the generation of electrical energy includes a fiael cell 1, which is designed in particular as what is known as a fuel cell stack comprising a large number of individual fuel cells. The fuel cell 1 includes an anode space 2 and a cathode space 3, which are separated by a proton-conducting membrane 4. As a result of an electrochemical reaction between anode and cathode, the fuel cell I generates an electric voltage which can be tapped off at output lines 5, 6. Fuel gas, in particular hydrogen, is oxidized at the anode, and oxygen, which in particular is contained in the air, is reduced at the cathode. Hydrogen is fed to the anode space 2 from a fuel gas sourcef in particular a hydrogen source, for example from a tank 7, in which pressurized hydrogen is stored, via feed line 8 within which there is arranged a pressure-regulating valve 9. The pressure of the hydrogen at the inlet of the anode space 2 is measured using a pressure sensor.

An intake system for an oxygen-containing gas, in particular air, includes an air filter 12 connected downstream of an opening 10 of an intake passage 11. Further along the intake passage 11 there is a compressor 13, from which compressed air, the pressure of which is measured using a corresponding sensor 14, is fed into the cathode space.

The fuel cell 1 has a cooling device 15 or heat exchanger, throqgh which a liquid coolant? in particular water, mixed with an antifreeze, is passed. The entry or inlet 16 of the cooling device 15 is connected via a line 17 to a cooler or heat exchanger 41 and a coolant pump 18. The outlet 19 or exit of the cooling device 15 is connected to a vent line 20, which extracts any gases which are admixed or dissolved in the form of fine bubbles in the coolant which leaves .the fuel cell 1 via the outlet 19, and feeds them via a line 21 into a gas collection region 22 of a calming vessel 23. For the coolant, the vent line 20 likewise leads to the calming vessel 23, and opens out into the liquid level; the vessel 23 vessel 23 below the includes an exit below the level, This exit is connected to the intake liquid entry of the coolant pump 18 via a line 24.

The gas collection region 22 is connected, at an exit or outlet, to a pxessure-relieve valve 25, from which a discharge passage 26 or a pipeline runs to the air intake system. A moisture separator 27 may be arranged within the discharge passage 26, and coolant which is separated out at this separator is fed back from the separator via a line 28 into the calming vessel 23. The pipeline 26 opens out into the housing holding the air filter 12. The pressure relief valve 25, the discharge passage 26, the moisture separator 27 and the calming vessel 23 consist of antistatic materials. A filling line 29 provided with a valve and an outlet line 30 provided with a valve are provided at the calming vessel 23. At the cathode space 3, the fuel cell 1 has an exit or outlet 31 for reaction products or gases, which pass via a pipeline 32 into a moisture separator 33, which removes water from the reaction products; the water can be fed back into the fuel cell system or discharged to atmosphere. By way of example, some of the water can be fed to the intake air, which is supposed to have a certain humidity level when it flows into the fuel cell 1 in order to keep the membrane 4 moist.

A catalyst 34, which oxidizes the hydrogen gas contained in the exhaust-gas stream, is connected downstream of the moisture separator 33, in a housinq which is not shown in more detail.

A sensor 35 at the exit of the housing of the catalyst 34 records the hydrogen content in the exhaust-gas stream and transmits the measured values to a control unit 36. The exit of the housing of the catalyst 34 is connected to an exit line 37, which has a feed line 38 in which a slide or a valve 39 actuable by the control unit 36 is arranged. At the entry to the feed line 38 there is a fan 40 which is switched on and off by the control unit 36. The cooler 41 arranged between the coolant pump 18 and the inlet 16, within the line 17, can be supplied with cooling air by a fan 42.

As the coolant flows through the fuel cell 1, it is heated. Hydrogen and/or air can enter the liquid coolant throuqh diffusion and/or leaks. In particular the penetration of hydrogen is critical, since in certain concentrations hydrogen can form an ignitable mixture with oxygen. The quantity of hydrogen and/or oxygen or air which can penetrate into the coolant cannot be determined. The invention prevents the cooling circuit from being put at risk by the penetration of hydrogen and/or air into the coolant.

The coolant, which may contain extremely small bubbles of hydrogen and/or air, passes into the vent line 20 from the cooling device 15. A line of this type is also known per se as a debubbling line. In the vent line 20, the coolant passes to a bubble separator. The gases which are separated out in the vent line 20 flow into the gas collection space 22 of the calming vessel 23. The coolant flows out of the vent line 20 into the calming vessel 23, in which it, in turn, comes into contact with a bubble separator, which separates gas bubbles out of the liquid. The gas which is separated out rises upward into the gas collection space 22, The more the coolant is heated, the more quickly the gases are removed from the coolant. The gas which has escaped from the coolant generates a rising pressure in the calming vessel 23. If a pressure limit value set at the pressure relief valve 25 is reached or exceeded, the pressure relief valve 25 opens, with the result that gas flows into the discharge passage 26 having the moisture separator 27. The gas may contain hydrogen and/or oxygen in various concentrations which depend on the diffusion or leak rate in the fuel cell 1. Ignition of this gas mixture is avoided on account of the antistatic materials used for the components with which the gas mixture comes into contact. in the housing of the air filter 12, the gas mixture is mixed with the air stream, the mass of which far exceeds the mass of the gas mixture supplied. Consequently, the gas mixture is very strongly diluted, i.e., even in the case of hydrogen gas the concentration of the hydrogen in the air stream is reduced to a very low level.

Any hydrogen which may be present in the air stream 35 passes into the cathode space 3 with the air stream and leaves the cathode space with the reaction gases via 31. After the water separation in the the outlet moisture separator 33, the reaction gas which remains, together with any small amount of hydrogen, flows across the catalyst 34, with the result that the hydrogen content is reduced still further. The hydrogen content of the gas downstream of the catalyst 34, which is measured by the sensor 35, is compared with a stored, predetermined value in the control unit 36. If this predetermined value is reached or exceeded, the control unit 36 opens the valve 39 and switches on the fan 40, with the result that the exhaust-gas stream is mixed with air. The hydrogen content in the exhaust-gas stream can be reduced to levels which are not critical and are not environmentally damaging by this mixing with air.

Before the cooling device is started up, air is pumped into the calming vessel 23 via the inlet line 29, with the result that the vessel and the discharge passage 26 are purged all the way to the air filter 12. After the coolant pump 18 has been switched off, the compressor 13 continues to operate for a short time, with the result that any hydrogen which may be present in the air intake system is flushed out.

A fuel cell system of the type described above, having the cooling device and the cooling circuit, is particularly suitable as an energy source in a mobile device, such as an electric vehicle.

1. A method for cooling a fuel cell system having a fuel cell, which comprises an anode space, to which a hydrogen-containing gas is fed, and a cathode space, to which an oxygen-containing gas is fed via an air intake system, a cooling device, which forms part of a cooling circuit through which a liquid coolant is passed, being arranged at least in the fuel cell, comprising:
separating gaseous constituents contained in the liquid coolant; and
providing an ignition source free discharge path for separating gaseous constituents contained in the liquid coolant wherein said ignition free discharge path is provided external to said fuel cell is fed to the air intake system.

2. The method as claimed in claim 1, wherein coolant which emerges from an exit of the cooling device of the fuel cell is fed to a calming vessel, from which gas is discharged at a preset excess-pressure level, the gas being fed via the discharge passage to the mass flow of oxygen-containing gas of the air intake system, and which is closed when the pressure drops below the excess pressure level, in order to prevent gas from escaping to the discharge passage.

3. The method as claimed in claim 1, wherein gas which is present in the liquid coolant is separated out of the coolant upstream of the calming vessel by means of a vent line and is then fed into the calming vessel.

4. The method as claimed in claim 1, wherein gases 12 discharge passage are fed to the mass flow of air in the region of an air filter of the air intake system.

5. The method as claimed in claim 1, wherein the hydrogen content of the exhaust gases from the fuel cell is monitored using a hydrogen sensor, and in that when a preset limit value for the gas content is reached the concentration of hydrogen in the exhaust gas is reduced to below the threshold value by admixing hydrogen-free gas.

6. The method as claimed in claim 1, wherein exhaust gases from the fuel cell are passed over a catalyst, by means of which the hydrogen concentration In the exhaust gases is reduced.

7. The method as claimed in claim 1, wherein a compressor in the air intake system for feeding air into the fuel cell remains switched on after the fuel cell has been switched off and the circulation of coolant has been shut down, so that it continues running for a predeterminable period of time.

8. The method as claimed in claim 2, wherein the calming vessel is purged with air before the coolant circuit is started up.

9. An apparatus for cooling a fuel cell system having a fuel cell which includes an anode space. to which a hydrogen-containing gas is fed, and a cathode space, to which an oxygen-containing gas is fed via an air intake system, a cooling device, which forms part of a cooling circuit through which a liquid coolant is passed, being arranged at least in the fuel cell, said system further including
a calming vessel for the liquid coolant with a gas collection region connected downstream of an outlet or exit of the cooling device of the fuel cell;
a gas outlet valve arranged at a gas collection regions, said valve able to be actuated at a predeterminable gas volume or gas pressure in the calming vessel and an outlet of said value is connected, via an ignition source free discharge passage, to the intake system of the oxygen-containing gas.

10. The apparatus as claimed in claim 9, further including a vent line arranged between the exit or outlet of the cooling device of the fuel cell and the gas collection region of the calming vessel.

11. The apparatus as claimed in claim 9, wherein the discharge passage which leads away from the calming vessel opens out in the gas intake system for the oxygen-containing gas in the region of a gas filter.

12. The apparatus as claimed in claim 9, further including a sensor for measuring the fuel gas content in the exhaust-gas stream provided in an exhaust pipe for reaction products of the fuel cell, said sensor being connected to a control unit, in which a limit value for the fuel gas content in the exhaust-gas stream is set and by which a valve in an entry to the exhaust pipe is controlled, which valve opens up an opening for admixing air to the exhaust-gas stream when a limit value is reached.

13. The apparatus as claimed in claim 12, further including a catalyst within the exhaust pipe for reducing the fuel gas in the exhaust-gas stream.

14. The apparatus as claimed in claim 9, wherein the calming vessels, the gas outlet valve and the gas discharge passage consist of antistatic materials.

15. The apparatus as claimed in claim 9, further including a moisture separator made from antistatic material arranged within the discharge passage.

16. The apparatus as claimed in claim 9, wherein said fuel system is positioned in a mobile device.

17. The apparatus as claimed in claim 10, wherein the discharge passage which leads away from the calming vessel opens out in the gas intake system for the oxygen-containing gas in the region of a gas filter.

18. The apparatus as claimed in claim 10, further including a sensor for measuring the fuel gas content in the exhaust-gas stream provided in an exhaust pipe for reaction products of the fuel cell, said sensor being connected to a control unit, in which a limit value for the fuel gas content in the exhaust-gas stream is set and by which a valve in an entry to the exhaust pipe is controlled, which valve opens up an opening for admixing air to the exhaust-gas stream when a limit value is reached.

19. The apparatus as claimed in claim 11, further including a sensor for measuring the fuel gas content in the exhaust-gas stream provided in an exhaust pipe for reaction products of the fuel cell, said sensor being connected to a control unit, in which a limit value for the fuel gas content in the exhaust-gas stream is set and by which a valve in an entry to the exhaust pipe is controlled, which valve opens up an opening for admixing air to the exhaust-gas stream when a limit value is reached.

20. An apparatus for cooling a fuel cell system having a fuel cell which includes an anode space. to which a hydrogen-containing gas is fed, and a cathode space to which an oxygen-containing gas is fed via an air intake system, a cooling device, which forms part of a cooling circuit through which a liquid coolant is passed, being arranged at least in the fuel cell, said system further including;
a gas outlet valve arranged at a gas collection region, said valve able to be actuated at a predeterminable gas volume or gas pressure and an outlet of said value is connected, via an ignition source free discharge passage, to the intake system of the oxygen-containing gas.
